(19) United States
(12) Patent Application Publication
(10) Pub. No.: US 2024/0378713 A1
(43) Pub. Date: Nov. 14, 2024

(54) PROCESS FOR ANALYZING OF A LIQUID SAMPLE WITH BUBBLE DETECTION

(71) Applicant: THERMO FISHER SCIENTIFIC S.p.A., Rodano (IT)

(72) Inventors: Riccardo FACCHETTI, Rodano (IT); Simone VANTINI, Milano (IT); Tiziano BOSAGLIA, Rodano (IT); Alessandra MENAFOGLIO, Milano (IT); Riccardo PASCUZZO, Milano (IT)

(73) Assignee: THERMO FISHER SCIENTIFIC S.p.A., Rodano, MI (IT)

(21) Appl. No.: 18/692,748

(22) PCT Filed: Sep. 16, 2022
(86) PCT No.: PCT/IB2022/058767

§ 371 Date: Mar. 15, 2024

(30) Foreign Application Priority Data
Sep. 16, 2021 (IT) 102021000023882

(51) Int. Cl. G06T 7/00; G01N 35/10; G06T 7/90

(52) U.S. Cl. CPC G06T 7/0002; G01N 35/1079; G06T 7/90; G06T 2207/10024

(57) ABSTRACT

The present invention relates to a method for the analysis of a liquid sample by means of an analysis system comprising: a sampling device, equipped with at least a syringe having a duct for drawing the sample, and a plunger movable in the duct; an image capture device: a computer equipped with an image analysis software application: and a device for analyzing the sample: in which the method comprises the steps of: A. drawing the liquid sample from a container by means of the syringe: B. operating said image capture device to capture one or more images of the syringe at the area of the syringe where the liquid sample was drawn: C. performing an analysis of the image by means of said computer. to detect the presence of bubbles in the liquid sample: D. if the presence of one or more bubbles was detected in said step C. performing one or more bubble elimination cycles, and preferably repeating at least said steps B and C thereafter, and if necessary also said step A prior to said steps B and C: E. if a bubble was not detected in said step C. or if a predefined number of bubble elimination cycles by one or more repetitions of said step D have been carried out, delivering the sample from the syringe to the analysis device, to carry out the analysis of the liquid sample.

### FIELD OF INVENTION

The present invention relates to the field of analysis of liquid samples contained in containers (typically vials). The liquid sample is drawn, typically by means of an autosampler, using a syringe, and then delivered to an analytical device.

### KNOWN PRIOR ART

The syringe, as it is known, specifically comprises a duct within which the sample is drawn, and a movable plunger in the duct. By moving the plunger so as to increase the space in the duct for the liquid (i.e., by moving it away from the needle tip of the syringe), a depression is provided in the duct, which allows the liquid to be drawn into the syringe. When compression is applied to the liquid by the plunger, that is, when the plunger is moved toward the needle of the syringe, the liquid is pushed out of the syringe.

The suction process involves the risk of forming gas bubbles in the duct of the syringe, inside the liquid sample. The presence of gas has several disadvantages including the presence of less liquid inside the duct than in a normal condition and contamination of the sample. Subsequent analysis of the sample is therefore compromised since said analysis is performed under the assumption that a predetermined volume of liquid has been drawn and the liquid is uncontaminated.

In fact, autosamplers are specifically designed to draw a defined amount of a liquid sample from a vial by syringe; one of the most important operational parameters of an autosampler is the repeatability of its operations, and in particular its ability to always draw the same amount of liquid into the syringe.

Therefore, methods for removing bubbles from the syringe cylinder are known in the art. One known method is to perform one or more compressions of the sample by means of a limited stroke (typically a plurality of limited strokes) of the plunger. This method is known in the art for example as “bubble elimination strokes” or “plunger strokes.”

This is repeated before each injection of the sample from the syringe to the testing device. While this solution reduces the number of analyses compromised by the presence of bubbles, it has several disadvantages.

First, to automate the process, said bubble elimination operations are repeated each time after drawing the sample from the vial, before injecting it into the analysis device.

As a result, said operations are carried out even if no bubbles are present in the sample, slowing down the analysis process.

Moreover, the system is programmed to perform a predetermined number of compression cycles on the sample. If bubbles are present, this number of compressions may not be sufficient to ensure elimination of the bubbles. Therefore, even with such a system, it is possible for some analyses to be compromised by the presence of bubbles in the sample.

Thus, the object of the present invention is to solve the problems described above.

It is the object of the present invention, in particular, to provide an analysis method, and a respective system suitable for carrying out said method, that solves the problem of the presence of bubbles in the syringe for drawing the sample from the related container.

### SUMMARY OF THE INVENTION

These and other objects are obtained by the present invention according to one or more of the appended claims.

Specifically, one aspect of the present invention relates to a method for analyzing a liquid sample by means of an analysis system comprising: a sampling device, equipped with at least one syringe having a sampling duct and a plunger movable within the duct; an image capture device; a computer equipped with image analysis software; and a sample analysis device. Specifically, this method comprises: a step A of taking the liquid sample from a container by means of a syringe; a step B of operating the image capture device to capture one or more images of the syringe at the area of the syringe where the sample was drawn; and a step C of performing an image analysis by computer to detect the presence of one or more bubbles in the liquid sample.

Subsequently, if one or more bubbles were detected in step C, the method comprises a step D of performing one or more bubble elimination cycles, and then preferably repeating the aforementioned steps B and C. If necessary, an additional sample may be taken by repeating step A as well. In particular, during the sampling procedure, step A may be repeated if the volume of liquid inside the syringe is less than a certain value.

The syringe typically has a duct, into which the sample is drawn, and a needle fluidly connected to the duct. In a known manner, the needle is configured to pierce a container that contains the sample. A plunger is typically movable axially within the duct, so that moving the plunger away from the needle results in a depression within the duct, which is suitable for promoting drawing of the sample from the container into the duct. Similarly, once the sample has been drawn by the syringe, moving the plunger toward the needle causes the sample to be compressed, or otherwise exerts a pressure on the sample, possibly to the point of causing the sample to be ejected from the needle, for example, during the step of delivering the sample from the syringe.

In step A, therefore, the syringe needle is typically inserted into the container, usually by puncturing a surface of said container, and the plunger is actuated so as to cause a depression within the duct to draw the sample from the container.

During the bubble elimination step, a portion of the sample may be ejected from the syringe due to the rapid movements of the plunger that are configured to compress the sample so that the bubbles are removed. At the end of the bubble elimination step, after N elimination cycles, it is therefore possible to draw the sample again, repeating step A so as to bring it back to the desired volume. For example, step A may be repeated if the volume inside the syringe is less than 80% of the maximum volume to be sampled.

This volume may be estimated through the analysis of the images.

After the bubble elimination cycles, i.e., after a first time of carrying out step D, images of the syringe are preferably again captured to verify the effective elimination of the bubbles. Therefore, if bubbles are again detected after the new image analysis, the bubble elimination step is repeated, and then new image analyses of the syringe are carried out, etc.

Once no presence of one or more bubbles has been detected in step C, the method involves a step E of delivering the sample from the syringe to the analysis device, to carry out the analysis of the liquid sample.

Typically, step E comprises moving the plunger toward the syringe needle, so as to compress, or otherwise exert pressure on, the sample to cause it to be ejected from said syringe needle. The autosampler is then configured, in a known manner, to place the syringe at the analysis device or at a delivery element suitable for sending the sample to the analysis device.

It should be noted that the aforementioned step C may be the first execution of step C, or the step executed following a bubble elimination step.

In short, then, according to a preferred aspect of the invention, the image analysis and bubble elimination steps are repeated until in step C the presence of bubbles is no longer detected. If the sample has no bubbles from the beginning, step D is not carried out, and the method carries out step E directly. According to one possible aspect, it is possible that the bubble elimination cycles may not be sufficient to remove the bubbles, regardless of the number of repetitions of steps B, C, and D discussed above.

In this case, the system may be programmed to perform a maximum number of repetitions of these steps. If the presence of one or more bubbles is again detected after this maximum number, the system may be programmed to discard the sample, or to still perform the analysis of the sample; in this case, the system is programmed to report in the respective analysis that the analysis was performed on a sample with bubbles. As better discussed below, the image analysis may allow not only the presence of bubbles to be detected but also their size to be estimated. In this case, the system may estimate the amount of liquid sample actually present in the syringe, so that this may be recorded in the respective analysis.

However, the possibility of proceeding to the sample analysis following step D, i.e., without performing a check on the actual elimination of the bubbles (and thus without repeating steps B and C), is not ruled out. In general, this solution is less preferred because it does not allow the effectiveness of the bubble elimination cycle to be verified. However, like the previous alternative, this solution advantageously allows such a cycle to be carried out only in cases where the presence of one or more bubbles in the sample has actually been verified, avoiding bubble elimination cycles in bubble-free samples. This method therefore allows for rapid operations to the system, and is particularly suitable in cases, for example, where the properties of the sample to be analyzed make the bubble elimination cycle particularly effective, so that it is unnecessary to test its effectiveness.

In general, thanks to the present solution, bubble elimination cycles may be avoided on samples where bubbles are not present.

The solution with verification of the effectiveness of the bubble elimination cycles also makes it possible to avoid analyzing liquid samples provided with bubbles or, in any case, if samples with bubbles are analyzed, to record which analyses were performed on samples with less than the expected amount of sample. 5

An operator who must consult the result of analyses performed by a system according to said solution is therefore able to identify analyses performed on samples without bubbles. Possibly, if the system has obtained data on bubbles, particularly relating the bubbles size, an operator may be able to obtain useful data from said analyses as well, taking into account the type, particularly size and/or quantity, of the bubbles detected.

According to one possible aspect, step C comprises the step of detecting the variation or gradient of a characteristic of the pixels of the image, preferably relative to pixel color and/or brightness, along a direction that intersects the liquid sample in the syringe. Preferably said characteristic is the so-called “gray value,” or “gray level,” terms used interchangeably in the following, better known in the art as “gray level.”

Indeed, the liquid sample to be analyzed typically exhibits substantially uniform coloration. The pixels of the image where the liquid is present show substantially zero variation. On the other hand, the bubble typically presents different color/brightness in different areas. In general this is due to the refraction of light on the bubble. The pixels of the image on a line intersecting the bubble then exhibit a change in a characteristic, typically related to their color and/or brightness, along the line. In other words, different pixels placed on said line have at least one different characteristic, typically different color and/or brightness. It should be noted that algorithms to detect, for example, color and intensity of a pixel in an image are known in the art and are not discussed in detail here.

Preferably, the analysis is done in such a way as to verify a change in brightness above a certain threshold along a direction substantially perpendicular to the axis of the syringe.

The variation of this characteristic along this line is therefore different than zero. Due to this, the system is able to verify the presence of the bubble.

It should be noted that in reality even the liquid may minimally refract light, just as the pixels of the image arranged in the liquid sample may not have exactly the same color value and/or intensity. Thus, the system is typically programmed to determine the presence of a bubble not whenever the aforementioned difference between different pixels is different than zero, but when that difference is greater than a predetermined threshold.

This threshold may be determined experimentally, for example, depending on the type of image capture device, the brightness of the environment, the type of syringe and liquid used, etc.

Once this threshold value is determined, the system is capable of automatically recognize the presence of bubbles inside the syringe.

According to a possible aspect, the operation of detecting the aforementioned gradient is repeated for pixels arranged on a plurality of distinct directions, which are parallel to each other. Preferably, at least directions perpendicular and/or parallel to the axis of the syringe sampling duct are chosen. As discussed above, preferred solutions use directions (i.e., lines) substantially perpendicular to the axis of the sampling duct of the syringe.

In other words, this characteristic difference between different pixels is evaluated by analyzing pixels arranged on a plurality of lines perpendicular to the duct of the syringe. In this way, as better discussed below, it is possible not only to assess the presence of a bubble but also to estimate its size.

It should be noted that, by means of an alignment algorithm, known in the art, it is possible to identify the axis of the duct of the syringe in the captured image, so as to define the directions (i.e., lines) along which to perform the analysis on the pixels of said image.

According to a possible aspect, the operation of evaluating the difference between the value of the characteristic in pixel pairs is carried out, the first pixel of each pair being arranged along a first direction parallel to the axis of the duct, the second pixel of each pair being arranged along a second direction parallel to the axis of the duct, distinct from the first direction, the pixels of each pair also being arranged on a same line perpendicular to the first and second directions.

Typically, the presence of a bubble causes said difference between the values of the characteristic of the pixels to exceed a predefined threshold.

It is also possible to define a function Z=f (X, Y), where X and Y are the coordinates of the pixels of the image in a reference system defined by two directions orthogonal to each other in the plane of the image, and Z is the value of the characteristic of the pixel placed at the X and Y coordinates of the image, and to evaluate the variation of Z as a function of X and/or Y.

Specifically, once said function is obtained, it is possible to estimate the slope of at least one segment of a line that intersects the function Z=f (X, Y) at at least two points having the same X coordinate and different Y coordinates, where the X coordinate refers to a direction parallel to the axis of the duct.

Typically, the slope of this segment is greater than a predefined threshold when a bubble is present.

In the embodiments discussed above, the default threshold is typically a function of the system used (e.g., it is typically dependent on the type of sensor used to capture the image, as well as the sample used). This predefined threshold may be estimated in different ways, for example by carrying out preliminary tests (generally by performing analyses in situations where bubbles are present and where bubbles are absent), or it may be estimated depending on the characteristics of said system.

According to one possible aspect, when, and if, (at least) one bubble elimination cycle is performed in the aforementioned step D, the liquid sample is compressed by the plunger, preferably a plurality of times, to promote bubble elimination.

An aspect of the present invention also relates to an analysis system comprising: a sampling device, provided with at least one syringe having a sampling duct, and a plunger movable within the duct; an image capture device; a computer provided with an image analysis software application and programmed to perform at least step C of a method according to one or more of the preceding aspects; and a sample analysis device.

The computer is typically configured so that it may control the entire method, that is, so that it may control the various elements of the system so that it may carry out all of steps A-E of the method above discussed. It should be noted that the computer may be a single unit (e.g., a single CPU) or a collection of multiple control units (e.g., a plurality of CPUs).

In general, the system typically comprises at least one control unit or computer to control the operations of at least some of the system's components.

As discussed, the sampling device is typically an autosampler.

### BRIEF DESCRIPTION OF THE FIGURES

With reference to the attached figures, illustrative and non-limiting embodiments of the present invention are now discussed, wherein:

FIG. 1 is a schematic view of a system according to an embodiment of the present invention;

FIG. 2A is a view of an image captured by the imaging device of the system in FIG. 1;

FIGS. 2B and 2C are views of possible results following an analysis of the image in FIG. 2A;

FIG. 2D is an enlarged view of a detail of FIG. 2C;

FIG. 3 is a summary diagram of a possible method according to the present invention.

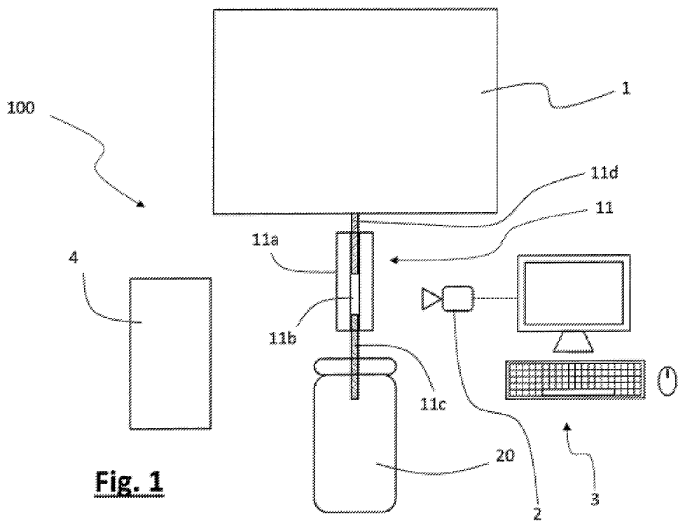

### DETAILED DESCRIPTION OF SOME EMBODIMENTS OF THE INVENTION

A system 100 according to an embodiment of the present invention comprises a sampling device 1, configured in a known manner to draw a liquid sample from a container 20, typically in the form of a vial or similar element. The sampling device 1 is typically an autosampler.

The sampling device 1 comprises a syringe 11. The syringe 11 has in a known manner a body 11a, crossed by a duct 11b for drawing a sample. The syringe 11 typically has a needle 11c, fluidly connected to the duct 11a, configured to pierce the container 20. In a known manner, a plunger 11d is movable axially within the duct, so that a movement of the plunger 11d away from the needle 11c results in a depression in the duct, suitable to promote the suction of the sample from the container 20 to the duct 11b. Similarly, a movement of the plunger 11d toward the needle applies pressure to the liquid sample 30, pushing it out of the syringe 11.

The sampling device 1 is thus typically provided with elements, not shown in detail, suitable to cause the plunger 11d to move.

The system 100 also features an image capture device 2 (henceforth also “imaging device 2”), preferably a device capable of capturing digital images, usually in the form of a digital camera. The imaging device 2 is arranged to capture images of the duct 11b of the syringe 11. The imaging device 2 may be configured to directly capture still images, or filmed sequences, from which still images may later be obtained.

The imaging device 2 is typically connected to a computer 3, known in the art, provided with a software application to perform an analysis of the images captured by the imaging device 2. The computer 3, in addition to performing image analysis, is also typically used to control other system operations, e.g., it may be configured to control the operations of the imaging device 2 and/or sampling device 1.

The system 100 further comprises a device 4 to perform an analysis of the liquid sample, such as a chromatographic analysis, known in the art, and not discussed in detail here.

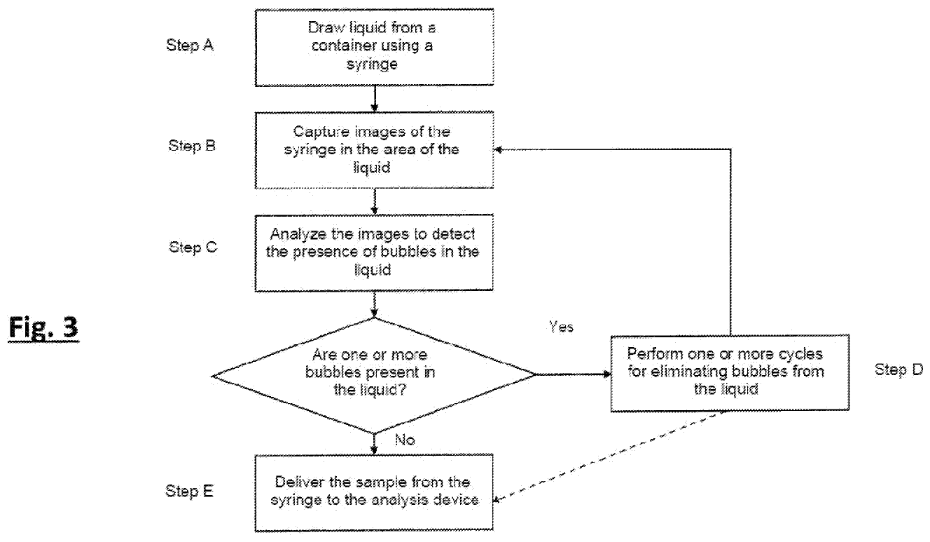

As for example schematized in FIG. 3, in use, in a first step (step A) the syringe 11 is operated in such a way as to draw a liquid sample from the respective container 20, typically by partially inserting the needle 11c of the syringe 11 into the container 20, and operating the plunger 11d in such a way as to create a depression within the duct 11b.

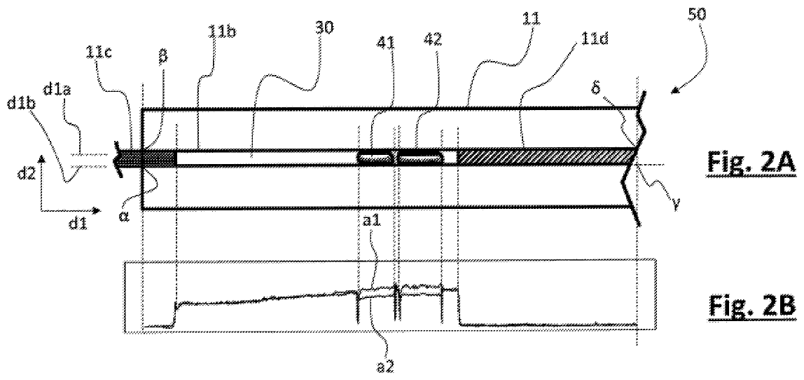

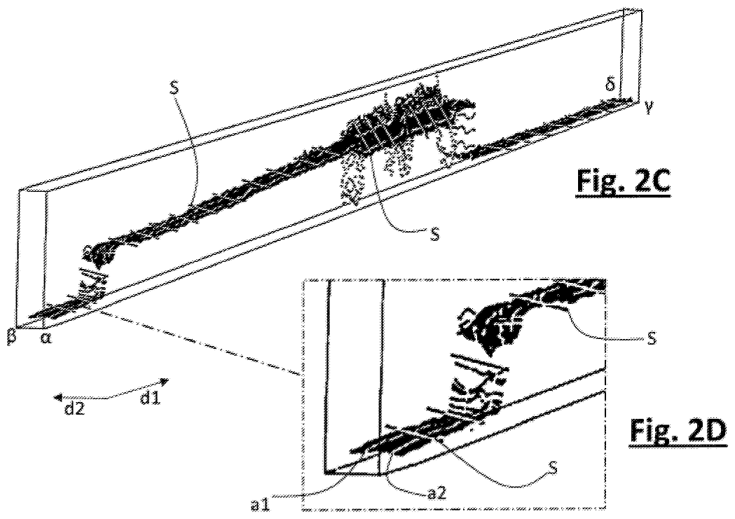

With reference also to FIG. 2, the liquid sample 30 is thus located within the duct 11b of the syringe 11.

Then, in a second step (step B), the imaging device 2 captures one or more images of the syringe 11, and in particular of the area of the syringe 11 where the liquid sample 30 is present.

In a third step (step C), this image is then analyzed by the computer 3, which, thanks to a relevant software application, is able to detect the possible presence of bubbles 41, 42.

Preferably, the computer 3 detects the change in a characteristic of the pixels of the image along one or more directions, preferably the change in color and/or brightness of image pixels arranged along a line, or the difference in color and/or brightness between different pixels arranged on the same line.

The liquid sample 30 typically shows uniform coloration. The pixels of the image placed at the sample thus exhibit substantially zero, or at least minimal, variation in the respective characteristic along one direction. In contrast, at any bubble 41, 42, the color and/or brightness of the image pixels varies along at least one direction. As discussed above, this direction is preferably angled (i.e., not parallel) with respect to the axis of the duct of the syringe 11, more preferably angled at least 45° to said axis, even more preferably substantially orthogonal to said axis.

Thus, if the computer 3 detects a change in a characteristic of the pixels along one direction, the system 100 identifies the presence of at least one bubble 41, 42 within the syringe 11. In this case, an additional step (step D) is performed, in which one or more bubble elimination cycles are carried out. Then at least the steps of image capture and analysis (steps B and C) are repeated.

A possible solution is described here in detail by way of example.

The imaging device 2 captures an image 50 of the syringe 11, such as shown in FIG. 2A.

Preferably, to facilitate subsequent operations of verifying the presence of bubbles 41, 42, the image 50 is typically converted to grayscale.

Then, in a known manner, the computer identifies the duct 11b, and specifically the area of the duct 11b where the liquid sample 30 is present. For example, this may be done by identifying the needle 11c and the plunger 11d in the image 50. In fact, these components generally exhibit different coloring than the remaining elements visible in the image. Usually, as for example in FIG. 2A, the needle 11c and the plunger 11d are placed at the darkest areas of the captured image 50.

In general, for easier image analysis, it is preferable for the needle and the plunger to have different color and/or brightness than the sample contained in the syringe.

Preferably, the needle 11c and the plunger 11d are black in color, or at least have a darker color tone than the sample, so that the gray value of the pixels located at these points is close to zero, or at least significantly lower than that of the sample.

These areas are then recognized by the computer 3 as the needle 11c and the plunger 11d. Thus, the space between the needle 11c and the plunger 11d represents the liquid sample 30. Preferably, therefore, only pixels between the needle 11c and the plunger 11d are analyzed, or pixels arranged only at the duct 11b, i.e., including those at the needle 11c and the plunger 11d, but not those at the body 11a, outside the duct 11b of the syringe. For example, as better discussed below, the analysis that led to the result in FIG. 2C was performed between points α, β, γ, δ in FIG. 2A, i.e., in the rectangle having α, β, γ, δ as vertices. These points belong to the duct 11b of the syringe 11.

Next, the gray level of the pixels in the captured image 50 is measured along one or more directions. The gray level, also known as the gray value, is a well-known concept in computer science, and is not discussed in detail here. In general, an analysis of a characteristic of the various pixels in the image is carried out, preferably related to the color and/or brightness thereof.

Typically, the images are in RGB format, and are later converted in a known manner to grayscale. However, it is possible to work with different image formats (e.g. CMYK), possibly converting them to a format more usable by the system.

There are also known procedures for directly detecting the gray level of a color image, such as a pixel of an RGB image, without intermediate conversion of said image.

Moreover, the possibility of analyzing the variation in the level of a single color of various pixels in the image, for example, of the red level of pixels in an RGB image, is not excluded. However, the analysis of the gray level of pixels in an image (which is generally a function of all the colors of the pixel) is generally more accurate.

For example, FIG. 2B shows the gray value trend of the pixels in the image of FIG. 2A arranged along two directions d1a and d1b parallel to the axis of the duct 11b and distinct from each other, i.e., placed at a non-null distance, measured along a direction d2 perpendicular to the axis of the duct 11b. FIG. 2B thus shows two trends a1 and a2 of the pixel gray value of the image 50, a first trend a1 representing the trend of the pixel gray value arranged along a first direction d1a, and a second trend a2 representing the trend of the pixel gray value along a second direction d1b. Specifically, the X axis of the graph is the position along the direction d1 (measured on the respective axis d1a or d1b), while the Y axis is the gray value of the respective pixel.

As better discussed hereinafter, at the liquid sample 30, at the needle 11c, and at the plunger 11d, the pixels show substantially uniform coloration, i.e., with minimal changes in gray value in a direction parallel to the axis of the duct of the syringe 11.

The respective trends a1, a2 are therefore substantially horizontal at these areas.

Furthermore, the gray value of the pixels varies minimally, i.e., below a predetermined threshold, even moving along a direction perpendicular to the axis of the duct of the syringe 11. Because of this, the trends a1 and a2 are substantially overlapped and substantially indistinguishable at these areas.

In short, the gray value does not vary as a function of a direction d2 perpendicular to the axis of the duct 11b, that is, perpendicular to the direction d1. The first and second trends a1, a2 are substantially overlapped, so they are not distinguishable. In other words, the gray value of the pixels located at the needle 11c and the plunger 11d along the first direction d1a is substantially identical to the gray value of the pixels located at the needle 11c and the plunger along the second direction d1b.

In the present case, in grayscale, the color of the liquid sample 30 is a gray approximately intermediate between white and black. The gray value of the pixels arranged at the liquid sample is therefore intermediate between the maximum and minimum values possible. At the transition from needle 11c to liquid sample 30, the trend a1, a2 of the gray value exhibits a high slope, i.e., shows a high variation of this value, and then returns to basically horizontal at the liquid sample 30. Also in this case, the gray value of the pixels placed at the liquid sample 30 varies minimally as a function of the direction d2. Also in thei case, the two trends a1 and a2 are thus not distinguishable.

In the present case, the syringe contains two bubbles 41, 42. The contour of the bubbles shows coloration close to black. At the contour of the bubbles, therefore, the gray value of the respective pixels is close to zero. In fact, the peaks toward zero in the gray value of the pixels located at the edge of the bubbles are visible in the graph in FIG. 2B.

Moreover, in the “body of the bubble,” i.e., the space contained within the contour of the bubble, the pixels are lighter than at the edge, and the gray value of the pixels placed along the first direction d1a does not vary appreciably; this occurs similarly along the second direction d1b. In the graph, in fact, the gray value of the pixels placed in the body of the bubble returns to a value not dissimilar to that of the sample and remains substantially constant, i.e., between the peaks in the graph in FIG. 2B, it does not vary appreciably; at the body of the bubbles 41, 42, therefore, the trends a1 and a2 are substantially horizontal.

However, the gray value of the pixels placed in the bubble body varies along a direction perpendicular to the axis of the duct 11b, i.e., along a direction parallel to the direction d2. Therefore, the trends a1 and a2 at the body of the same bubble are spaced apart from each other. Specifically, in the present case, the pixels located at the bubbles 41, 42 along the first direction d1a are lighter than pixels located at the bubbles 41, 42 along the second direction d1b.

The trends a1 and a2 are thus substantially parallel, but at a distance from each other. This, in effect, allows for the evaluation of the difference between the pixels located at two different points on any line orthogonal to the axis of the duct of the syringe 11 that intersects the directions d1a and d1b, i.e., the points of intersection of the directions d1a and d1b with said line. As a result, this allows for the evaluation of the change in a characteristic of the pixels of the image in the direction orthogonal to the syringe 11. In fact, evaluating the difference between the trends a1 and a2 at the same abscissa corresponds to evaluating the difference between two pixels placed on a line orthogonal to the syringe 11, arranged at said abscissa.

In other words, evaluating the distance (measured in the direction of the ordinates) between the trends a1 and a2 is equivalent to evaluating the difference of the value of the characteristic between a pixel pair arranged at the intersection of a line perpendicular to the axis of the duct and the two directions d1a and d1b parallel to the axis of the duct. This may be repeated for a plurality of pixel pairs defined by the intersection of lines (one line for each pair) perpendicular to the axis of the duct and the two directions d1a and d1b.

In short, then, by analyzing the trend of pixels arranged along multiple directions parallel to the axis of the duct of the syringe 11, it is also possible to evaluate (in a discrete, i.e., noncontinuous manner) also the variation of the characteristic of the pixels even in directions transverse, including orthogonal, to the axis of the duct of the syringe 11.

Thus, the computer 3 is able to detect the presence of the aforementioned peaks and the aforementioned difference of the gray value along the Y axis in the direction d2 at the same point along the X axis in the direction d1 of the graph in FIG. 2, i.e., the distance between the trends a1 and a2 in an area of the graph; these indicators enable the computer 3 to detect the presence of the bubbles 41, 42. Moreover, the distance between the peaks in the graph allows the computer to evaluate the size, at least the size measured along the direction d1, of the bubbles 41, 42.

It should be noted that, for simplicity, the analysis of the pixels placed along only two directions d1a, d1b has been described. Said solution may be sufficient to obtain an indication of the presence of bubbles. However, it is possible to carry out said analysis along a plurality of directions. For example, FIG. 2C shows the result of a gray value analysis of pixels arranged along a plurality of directions parallel to the direction d1 and side by side in succession with each other. Due to this, it is possible to create a three-dimensional graph, having as its Z axis the gray value of a pixel, measured at the point having predefined coordinates, measured in the directions d1 and d2. For example, point α has coordinates (0, 0) measured in directions d1 and d2 respectively, while point δ has coordinates (Xₘₐₓ, Yₘₐₓ), which are the maximum values of the axes of the graph on the axes having directions parallel to the directions d1 and d2.

With reference also to the detail of FIG. 2D, it should be noted that, along the resulting surface, the trends a1 and a2 of FIG. 2B have been identified.

Further, segments S are drawn along the graph, which are part of lines arranged in planes orthogonal to the direction d1, and passing through the trends a1 and a2.

Said segments are substantially horizontal, i.e., substantially parallel to the plane containing d1 and d2, at the pixels of the image 50 arranged at the needle 11c, plunger 11d, and liquid sample 30. The slope of these segments increases significantly at the bubbles 41, 42. The computer 3 can then detect the presence of bubbles 41, 42 when the slope of these segments S exceeds a certain predefined threshold.

It should be noted that this may be done for simplicity by measuring the slope of the segments passing through two trends a1, a2, but it may be done by evaluating the slope of segments passing through a plurality of pairs of trends of the surface resulting from the analysis along a plurality of directions, or by an analysis of the average slope of that surface with respect to the plane containing the directions d1 and d2.

For example, the slope of the segment may be estimated by evaluating the difference between the value of the characteristic of the pixel, typically the gray value of the intersection points of the segment S with the two trends a1, a2, divided by the distance between the two points. Therefore, the slope may be calculated with the formula P=(V1−V2)/D, where P is the slope of S, V1 is the value of the characteristic at the intersection point between a1 and S, V2 is the value of the characteristic at the intersection point between a2 and S, and D is the distance between a1 and a2, measured in the direction d2.

According to one aspect, the system may be trained with images in which the syringe contains a sample with bubbles (and possibly also with images of samples without bubbles), so that said system may identify characteristics of the image indicative of the presence of bubbles.

For example, the analysis of said training images may help define the minimum variation in the characteristic of the pixels (e.g., gray value) between different pixels that is indicative of the presence of one or more bubbles. Taking into account the embodiments described above, the analysis of the training images may, for example, help define the minimum variation suitable for identifying a “peak” in FIG. 2B, and/or the threshold value for the variation of the characteristic in different pixels that identifies the presence of a bubble, such as the threshold value for the distance between two trends a1, a2 in FIG. 2B or for the slope of the segments S in FIG. 2C.

According to a possible solution, if the system is able to operate with different types of samples, or at least with samples having different characteristics, it is possible to define conditions for identifying the bubble that are different for different samples. For example, different threshold values of the variation of the characteristic of the pixels (such as the threshold value of the slope of a segment S in FIG. 2C) may be defined for different samples. It should be noted that “threshold” and “threshold value” are used interchangeably in the present discussion.

In general, a possible embodiment involves deriving the trends of a characteristic of the pixels as a function of their position in the image. This makes it possible to define a set of points having three coordinates (X, Y, Z), where X and Y represent the location of the analyzed pixel, identified by the point in the plane formed by the directions d1 and d2 (i.e., parallel and perpendicular to the axis of the duct, respectively), and Z represents the value of the characteristic (identified in the following for simplicity as “gray level,” although the following description may also be applied to different characteristics of the pixels).

The detection of the bubble may therefore be carried out by evaluating the change in gray value both in the direction parallel to the duct and in the direction orthogonal to the duct.

This is therefore equivalent to evaluating the shape of the surface obtained by evaluating the gray value at various points in the image, i.e., evaluating the shape of the surface Z=f(X,Y) (typically without considering the areas of the surface at the needle and plunger). At areas of the image where no bubble is present, said surface is substantially flat, or at least has a Z value with variation in the X and Y directions below a certain threshold. In areas where a bubble is present, the surface appears not to be flat. Typically, at least in the body of the bubble, the surface has areas with progressively increasing or decreasing Z values in the Y direction.

Alternatively, a plurality of directions orthogonal to the syringe axis may be used directly, and the variation of pixels along each of these orthogonal directions may be evaluated.

In general, several tools are available, which, following an analysis of the variation of the characteristic of a pixel, typically related to brightness and/or color of the pixel, along a direction, allow the computer 3 to detect the presence of bubbles 41, 42.

As discussed above, by analyzing the pixels of the image 50, it is possible to identify the presence of the bubbles, and assess their size. In particular, one or two dimensions of the bubble may be derived from an analysis of a two-dimensional image. For example, with reference to FIG. 2A, the length of a bubble (i.e., its dimension along the direction d1) may be estimated by evaluating the position of the peaks of the trends a1 and a2. The second and/or third dimension of the bubble may be estimated, typically as a function of the duct diameter 11b. For example, with reference to FIG. 2A, it may be considered that the bubble typically has a diameter equal to that of the duct of the syringe. Since the length and diameter of the bubbles are then known, it is possible to estimate their volume. A correction factor may be used, so as to take into account the terminal portions of the bubble, which typically have decreasing diameters.

Alternatively, it is possible to estimate length (along the direction d1) and width (along the direction d2) of the bubble as a function of the data obtained from the image, and to approximate the third dimension of the bubble as equal to its own width (i.e., the size of the bubble in the direction d2).

In general, by estimating the size of the bubbles, it is possible to estimate the amount of liquid sample actually present in the syringe 11, i.e., without considering the space occupied by any bubbles 41, 42 present therein.

As previously discussed, if the system 100 thus detects the presence of at least one bubble 41, 42, one or more cycles are performed to attempt to eliminate bubbles 41, 42. Typically, in said step (step D), the plunger 11d performs alternating ejection and suction strokes, at high speed, to mechanically eject the sample containing one or more bubbles from the syringe. Finally, the liquid is again drawn in at a slower rate. Next, it is preferable to acquire a new image to check for any persistence of bubbles 41, 42, and then possibly repeat the step of removing the bubbles 41, 42, if they are still present in the newly acquired image.

If, on the other hand, no bubbles are detected, a further step (step E) may be performed, where the liquid sample 30 may be delivered to an analysis device 4, known in the art and not discussed in detail here.

As discussed above, it is preferable to repeat the bubble detection operations following the elimination cycle to determine whether it is possible to continue with the method, or if it is necessary to perform a bubble elimination step again.

However, the possibility of operating with a bubble elimination cycle without rechecking the image is not excluded, so as to later proceed directly with the sample analysis step, as schematized by the dashed arrow in FIG. 3.

In the case of an image verification also following a bubble elimination cycle, it is possible that in the event that the system 100 is unable to remove the bubbles 41, 42 from the syringe 11, the system will get stuck in an endless cycle. In this regard, a maximum number of repetitions of the bubble elimination step may be predetermined.

Specifically, prior to the execution of the bubble elimination step (i.e., prior to step D), the system 100 may perform a check on the number of elimination cycles previously performed on the same sample. If this number of cycles exceeds a predefined threshold, several operations may be performed.

Preferably, this threshold value is between 1 and 5 bubble elimination cycles, more preferably between 1 and 15 bubble elimination cycles. Possible solutions involve this threshold being between 3 and 15 cycles, or 5 and 10 cycles.

According to two possible alternative aspects, if following this maximum number of repetitions (i.e., exceeding this threshold value) the presence of bubbles 41, 42 is again detected, the system 100 may be programmed to interrupt the analysis of the liquid sample 30, or to still perform the analysis thereof. In the second case, the system 100 is typically configured to record in the results of the analyses that these were performed on a suboptimal sample, with the presence of bubbles 41, 42. According to one possible aspect, when analyzing a sample with a bubble, if the system 100 was able to estimate the volume of the bubble, it is possible to estimate the volume of the liquid sample 30 actually present in the syringe by subtracting the volume of the bubble from the initially expected value. In this case, the actual amount of liquid sample 30 analyzed may be recorded in the results. In this case, once the actual amount of liquid sample 30 analyzed is known and recorded, it is possible to draw up the analysis report thereof by correcting the calculations for the actual volume of liquid analyzed and consequently obtain more accurate and reproducible results.

1-15. (canceled)

16. A method for analysis of a liquid sample with an analysis system comprising:
a sampling device, provided with at least one syringe having a duct for drawing the sample, and a plunger movable in the duct; a device for capturing images; a computer provided with a software application for image analysis; and a device for analyzing the sample; wherein the method comprises the steps of:
(A) drawing the liquid sample from a container with the syringe;
(B) operating said image capture device to capture one or more images of the syringe at an area of the syringe where the liquid sample was drawn;
(C) performing an analysis of the image with said computer to detect a presence of bubbles in the liquid sample;
(D) if the presence of one or more bubbles is detected in said step (C), performing one or more bubble elimination cycles, and repeating at least said step (B) and said step (C) thereafter, and if necessary, also said step (A) prior to said steps (B) and (C); and
(E) if a bubble is not detected in said step (C), or if a predefined number of bubble elimination cycles by one or more repetitions of said step (D) have been carried out, delivering the liquid sample from the syringe to the device for analyzing the sample to carry out the analysis of the liquid sample.

17. The method according to claim 16, wherein said step (C) comprises detecting a variation of a characteristic of pixels of the image along a direction intersecting the liquid sample in the syringe.

18. The method according to claim 17, wherein said characteristic of each pixel is related to color and/or brightness of the pixel.

19. The method according to claim 18, wherein said characteristic is related to a gray level of the pixel.

20. The method according to claim 17, comprising the operation of detecting said variation along at least two directions distinct and, preferably, parallel to each other and/or the operation of detecting the variation between the characteristic of pixels arranged at the intersection points between a line transverse to, preferably orthogonal to, these at least two directions, and said two directions.

21. The method according to claim 20, wherein said directions are substantially perpendicular and/or parallel to an axis of the sampling duct of said syringe.

22. The method according to claim 20, wherein said step (C) comprises the operation of evaluating a difference between a value of the characteristic in pairs of pixels, a first pixel of each pair being arranged along a first direction parallel to an axis of the duct, a second pixel of each pair being arranged along a second direction parallel to the axis of the duct, and distinct from the first direction, the pixels of each pair also being arranged on the same line perpendicular to said first and second directions.

23. The method according to claim 17, in which said step (C) comprises the step of defining a function Z=f(X, Y), wherein X and Y are coordinates of the pixels of the image in a reference system defined by two directions orthogonal to each other in a plane of the image, and Z is a value of the characteristic of the pixel placed at the X and Y coordinates of the image, and of evaluating the variation of Z as a function of X and/or Y.

24. The method according to claim 23, wherein said step (C) comprises the step of evaluating a slope of at least one segment of a line intersecting the function Z=f(X, Y) at at least two points having the same X coordinate and different Y coordinates, wherein the X coordinate refers to a direction parallel to an axis of the duct.

25. The method according to claim 17, wherein, during said step (C), the presence of a bubble is detected if the variation of said characteristic between different pixels along a direction exceeds a predefined threshold, preferably if the variation of said characteristic along a direction perpendicular to an axis of the duct exceeds a predefined threshold.

26. The method according to claim 16, wherein in said step (D), if at least one bubble elimination cycle is performed, the liquid sample is compressed by said plunger to promote bubble elimination.

27. The method according to claim 16, wherein if following a predetermined number of repetitions at least of step (D) of bubble elimination, the bubbles have not been removed, system operations are interrupted.

28. The method according claim 16, wherein if after a predetermined number of repetitions of step (D) of bubble elimination, the bubbles have not been eliminated, a volume of bubbles is estimated, so that the actual amount of liquid in the syringe is calculated, the liquid sample is delivered to the device for analyzing the sample, so that the device for analyzing the sample is operable to perform sample analysis according to the calculated actual amount of liquid in the syringe.

29. An analysis system, comprising:
a sampling device equipped with at least one syringe having a duct for drawing a liquid sample, and a plunger movable in the duct;
an image capture device; and
a computer equipped operable to perform an analysis of the image with to detect a presence of bubbles in the liquid sample.

30. The analysis system according to claim 29, wherein the sampling device is an autosampler.
